(19) United States
(12) Patent Application Publication
(10) Pub. No.: US 2008/0233255 A1
(43) Pub. Date: Sep. 25, 2008

(54) PROCESS FOR PRODUCING A FREEZER-TO-OVEN BAGEL

(76) Inventors: Keith A. Lockwood, Brownsburg, IN (US); Hugh P. Harlan, Indianapolis, IN (US)

Correspondence Address: BOSE MCKINNEY & EVANS LLP;2700 FIRST INDIANA PLAZA, 135 NORTH PENNSYLVANIA, INDIANAPOLIS, IN, 46204, US

(21) Appl. No.: 11/689,237

(22) Filed: Mar. 21, 2007

(51) Int. Cl. A21D 10/02

(52) U.S. Cl. 426/444

(57) ABSTRACT

A process for making a freezer-to-oven bagel product is provided. The process comprises mixing at least flour, water, salt and yeast to form a bagel dough, dividing the bagel dough to form individual bagel units, proofing the bagel units for about 2 to about 4 hours in a proof box, preliminarily freezing the bagel units for about 10 to about 30 minutes in a freezer, and blast freezing the bagel units for about 20 to about 30 minutes in a blast freezer. The proof box has an internal temperature of from about 68° F. to about 75° F. and a relative humidity of from about 80% to about 100%, the freezer has an internal temperature of from about 0° F. to about −10° F., and the blast freezer has an internal temperature of from about −20° F. to about −30° F.

### TECHNICAL FIELD

The present invention is related to bagels and a bagel making process, and more particularly to a process for producing a bagel product exhibiting desirable freezer-to-oven characteristics.

### BACKGROUND OF THE INVENTION

Over the past several years, bagels have become an increasingly popular food item. Part of this popularity is due to the fact that bagels can be prepared with a variety of ingredients, thereby appealing to the tastes of many different consumers. Despite having this variety, traditional bagels typically contain at least water, salt, flour and yeast and are made by a conventional process that includes boiling or steaming the dough before or during the baking process. These steps have all been found necessary when trying to achieve the distinctive mouth-feel, texture and appearance common to most bagels.

There have been many different manufacturing processes created to produce mass quantities of bagel products. Many of these processes require the bagels to be created at central locations and then shipped off-site to various facilities, which in turn bake the bagels and serve them to the consumer for ultimate consumption. To preserve the bagels during this process, the bagels are typically subjected to a freezing process after being manufactured. When the bagels are frozen in their raw state, they are of a much smaller size than when in their baked state. As such, the bagels must rise or proof substantially during the proofing process to reach their intended size and shape. During the proofing process, the bagel is in an unstable condition, and if proper care is not taken, then the bagel can misshapen and/or experience one or more unappealing surface flaws. In addition to experiencing problems during the proofing process, the bagel at the retail store level must also undergo an extensive proofing process after the bagel is removed from the retail store's holding/storage freezer. Again during this proofing process at the store level, the bagel is in an unstable condition and if proper care is not taken, then the bagel can misshapen and/or experience one or more unappealing surface flaws. Because of the extensive time needed to perform this post-freezer proofing process, many facilities are required to force their consumers to wait several hours before the bagel is ready to be baked and served.

As such, it is desirable to have a bagel and bagel making process that overcomes or improves upon one or more of the disadvantages noted above.

### SUMMARY OF THE INVENTION

The present teachings are generally directed to a fully fermented freezer-to-oven bagel process, as well as the bagels produced by such process.

According to one aspect of the present teachings, a process for making a freezer-to-oven bagel product is provided. The process comprises mixing at least flour, water, salt and yeast to form a bagel dough, dividing the bagel dough to form individual bagel units, proofing the bagel units for about 2 to about 4 hours in a proof box, preliminarily freezing the bagel units for about 10 to about 30 minutes in a freezer, and blast freezing the bagel units for about 20 to about 30 minutes in a blast freezer. The proof box has an internal temperature of from about 68° F. to about 75° F. and a relative humidity of from about 80% to about 100%, the freezer has an internal temperature of from about 0° F. to about −10° F., and the blast freezer has an internal temperature of from about −20° F. to about −30° F.

In yet another aspect of the present invention, the individual bagel units produced by the process have a first volume before the baking step and a second volume after the baking step, wherein the second volume is no more than 177% greater than that of the first volume, or the first volume is greater than 50% of the second volume.

### BRIEF DESCRIPTION OF THE DRAWINGS

The above-mentioned aspects of the present teachings and the manner of obtaining them will become more apparent and the teachings will be better understood by reference to the following description of the embodiments taken in conjunction with the accompanying drawings, wherein:

FIG. 1 shows a flow chart depicting an exemplary bagel producing process in accordance with the present invention; and

FIG. 2 shows a flow chart depicting an exemplary bagel handling and baking process in accordance with the present invention.

### DETAILED DESCRIPTION

The embodiments of the present teachings described below are not intended to be exhaustive or to limit the teachings to the precise forms disclosed in the following detailed description. Rather, the embodiments are chosen and described so that others skilled in the art may appreciate and understand the principles and practices of the present teachings.

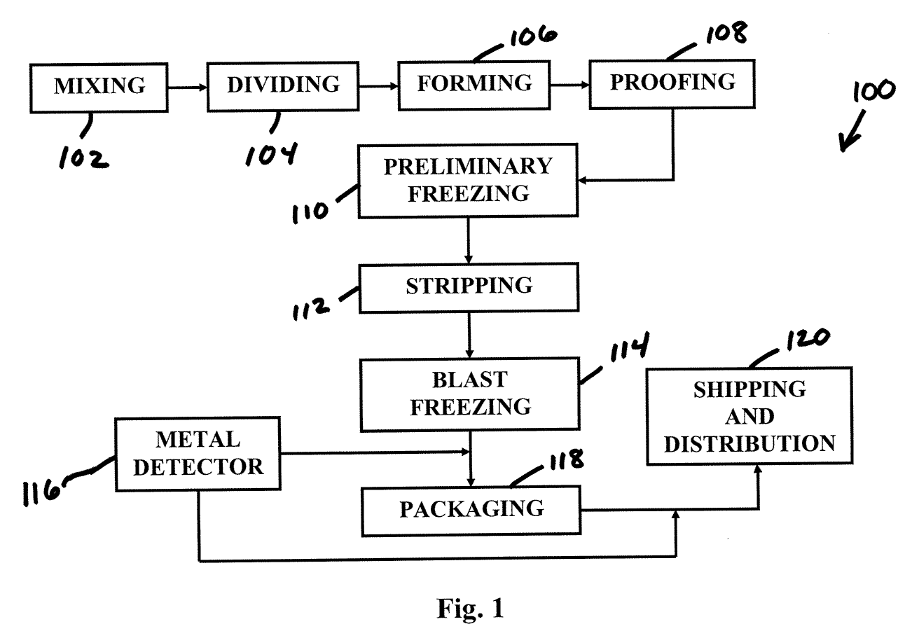

According to one aspect of the present invention as shown in FIG. 1, an exemplary freezer-to-oven bagel making process 100 is provided. The first step of this process (step 102)), involves the mixing of ingredients to create a batch of bagel dough that will be used to form the bagel products. It should be understood and appreciated herein that any conventional ingredients known within the bagel industry to form bagel dough products may be used in accordance with the present teachings. However, in certain exemplary embodiments, the dough is comprised of a mixture of at least flour, water, yeast and salt. An exemplary type of flour useful in accordance with the present process includes, but is not limited to, unbleached and enriched flour. The flour typically has a protein level (in percentage of weight) of about 11.5% to about 14.5% of the flour weight. The flour is added (in percentage of weight of the mixture) in a quantity of about 50% to about 70%, more particularly about 60%. Water, is added (in percentage of weight of the mixture) in a quantity of typically about 25% to about 35%, more particularly about 30%. Yeast is added (in percentage of weight of the mixture) in a quantity of typically about 0.5% to about 2.0%, more particularly about 1.2%, and salt is added (in percentage of weight of the mixture) to a quantity of about 0.7% to about 2.0%, more particularly about 1.2%.

In addition to mixing the above-referenced ingredients, other minor ingredients may also be added as desired. According to one aspect of the present invention, exemplary ingredients of the mixture may include the following, each ingredient being added in the provided percentage of the mixture as shown below:

TABLE 1

| Ingredient | Acceptable Range | Specific Amount |
|---|---|---|
| Flour | 50–70% | 60% |
| Water | 25–35% | 30% |
| Yeast | 0.5–2.0% | 1.2% |
| Non-diastatic malt dry | 0.2–1.0% | 0.6% |
| High Fructose corn syrup | 1.0–8.0% | 6.0% |
| Salt | 0.7–2.0% | 1.2% |
| Dough Conditioner | 0.5–5.0% | 1.2% |
| Natural Flavor | 0.2–2.0% | 0.3% |

The mixing process (step 102) typically takes about 10 to about 12 minutes and can be performed by any commercial horizontal or spiral dough mixing machines known within the bagel industry. An example of one such exemplary machine includes a Peerless Mixer, model number HS13FD, manufactured by Peerless Machinery Corporation of 500 South Vandemark Road, Sidney, Ohio 45365.

After the ingredients have been mixed, the temperature of the formed dough product must be closely monitored to make sure that the dough does not rise too quickly or too slowly. In certain aspects of the present invention, a useful temperature for the dough product is typically about 70° F. to about 82° F., and more particularly from about 76° F. to about 78° F. Once the ingredients have been mixed into a batch, the batch is then subjected to a chunking/dividing process (step 104), where the dough is placed in a chunker to create large strips of raw bagel dough. The strips of dough are then fed into a divider, where the dough is divided into individual portions that are representative of a single bagel unit. Typically, the individual bagel units have a scaled weight of from about 3.0 ounces to about 5.0 ounces (approximately about 85 grams to about 142 grams), and particularly around about 4.5 ounces (approximately 128 grams). After the dough is chunked into larger strips of raw bagel dough, the raw bagel dough goes through a transfer process into the divider, which typically takes about 12 minutes to about 15 minutes, and particularly about 13.71 minutes. During the mixing, chunking, transferring and dividing processes, the room conditions (i.e., temperature and relative humidity within the room in which the mixing occurs) should also be kept at optimal levels. In certain aspects of the present invention, the optimal room conditions are about 70% to about 80% relative humidity and around about 65° F. to about 75° F.

After the dough product has been divided, it is then formed into the shape of a bagel product (step 106). The forming of the bagel is typically accomplished by a forming machine, where the dough is advanced under a pressure plate that rolls the dough into tube-like shapes. The ends of the rolled dough are then wrapped around and meshed together to form the traditional bagel shape. Exemplary horizontal or vertical forming machines can shape about one bagel every second. While any commercial forming machines known within the bagel industry can be used in accordance with the present invention, one example of a useful forming machine is a horizontal forming machine having a 3.125″ sleeve, 2.0″ mandrel and 9.6 rough top 3-ply belt, such as the Baktek Quad bagel dividing bagel machine (rotary knife cut), model number BT24K, manufactured by BAKTEK of 290 Lindbergh Avenue, Livermore Calif., 94551.

Once the dough product has been formed into the shape of a bagel, the bagels are removed from the belt and put onto a cornmeal-coated board, a step that is commonly referred to as “panning” the bagels. It should be understood and appreciated herein that the board may be of any known size or shape depending on the desired quantity of bagels to be produced in any given batch; however, in certain exemplary embodiments, the board is comprised of a 3×5 pattern to accommodate approximately 15 bagels. According to this exemplary embodiment, the bagels are centered on the board in an arrangement having a 6.5″ width and 5″ length. While boards can be loaded at various speeds, in certain aspects of the present invention about 20-25 boards can be loaded every minute, more particularly 23.33 boards per minute (i.e., 1 board every 3.88 seconds). Once a board has been fully loaded with bagels, it is then placed on a rack. Exemplary racks in accordance with the present invention may accommodate approximately 52 boards (i.e., 65 dozen bagel products). These racks can be filled in about 2.29 minutes, or at a rate of 27 racks per hour.

After the dough products are formed and placed on the corn-meal coated boards, the products are subjected to a proofing process (step 108). More particularly, the boards are put into a proofing machine or proof box, where they experience specific levels of optimal heat and humidity conditions. As is known within the art, “proofing” is a term used in the baking industry to describe the process of causing yeasted dough products to rise or proof prior to being baked. When producing mass quantities of dough-related products, it is crucial that the proofing environment be kept stable during the entire proofing process. If the optimal temperature and relative humidity levels are not obtained or maintained, optimal proofing of the product will not occur. Moreover, if the temperature and humidity conditions are not kept uniform throughout the proofing box during the proofing process, consistent proofing of the dough products will also not occur. Essentially, the proof process allows the bagel product to enter an environment that is conditioned by both heat and humidity, thereby allowing the product to fully ferment (i.e., the yeast in the bagel gases the raw bagel dough, which is visibly seen in the rise or increased size of the raw bagel dough).

In certain exemplary embodiments in accordance with the present invention, the settings of the proof box are set at a relative humidity of approximately about 80% to about 100%, while the temperature is set at approximately from about 68° F. to about 75° F. The proofing process typically lasts from about 2 hours to about 4 hours, and more particularly from about 2 hours to about 2.5 hours. While the capacity of the proof box can vary in size and/or shape, in certain aspects of the present invention, the proof box may have a capacity of from about 95 to about 100 racks of bagels. It should be understood and appreciated, however, that those skilled in the art can use proof boxes with different capacity requirements without straying from the teachings of the present invention.

During the proofing process, it can be expected that the dimensions or volume of the bagels will likely increase as the bagels rise or proof. More particularly, when typical bagels exit the forming device, they often have a height of about 1.0 inch, a diameter of about 3.25 inches and a volume of 225 ml. After being subjected to the proofing process, however, their dimensions will somewhat increase. According to certain aspects of the present invention, the height of the bagel will increase to about 1.0 inch to about 1.7 inches, and more particularly to a height of about 1.15 inches to about 1.45 inches. Further, the diameter of the bagel will increase to about 4.0 inches to about 5.0 inches, and more particularly to about 4.4 inches to about 4.8 inches.

After the bagels are removed from the proofing process, they then undergo a preliminary freezing process (step 110). During this step, the bagels are subjected to optimal freezing conditions for a specific period of time. To achieve this freezing effect, the bagels are placed inside of a freezer, such as a standard commercial walk-in freezer, where the bagel's core temperature can be lowered to an acceptable range, for instance to a temperature from about 35° F. to about 55° F., more particularly to about 45° F. This core temperature is reached by setting the freezer to a temperature of from about 0° F. to about −10° F., and by leaving the bagels inside the freezer for about 10 minutes to about 30 minutes, more particularly for about 15 minutes to about 25 minutes. To measure the core temperature of the bagel, a hand held temperature probe is placed into the center of the bagel dough.

After the bagels have been subjected to the preliminary freezing step, the bagels are then stripped from the boards (step 112). More particularly, the bagels are stripped from the boards with a depanning conveyor system, such as manufactured by Kleenline Corporation of 7 Opportunity Way, Newbury Port, Mass., 01950. After being stripped from the boards, the bagels are then subjected to a blast freezing process (step 114). To achieve this blast freezing effect, the bagels are placed within a blast freezer device. While any known blast freezing devices can be used in accordance with the present invention, exemplary spiral blast freezers such as those manufactured by FMC Food Tech Inc. of Sandusky, Ohio may be used in certain embodiments. As is known within the bagel producing industry, spiral blast freezers freeze bagel dough with minimum damage to yeast cells; cells which are needed to generate gas in the later thawing and baking steps of the traditional bagel production process. Also, spiral blast freezers are able to freeze bagels relatively quickly, which is desirable from a mass production standpoint.

According to certain exemplary embodiments of the present invention, the spiral blast freezers have an internal temperature of from about −20° F. to about −30° F., more particularly about −29° F. While in the blast freezer, the core temperature of the bagel is lowered to an optimal temperature of from about 0° F. to about 10° F., more particularly about 5° F. To achieve this core temperature, the bagels are typically kept within the blast freezer for about 20 minutes to about 30 minutes.

After the bagels are subjected to the blast freezing process, the bagels are optionally scanned by metal detection devices (step 116) prior to and/or after being packaged (step 118) for shipping and distribution (step 120). Once the bagels have been packaged, they are then stored in holding freezers, which are typically maintained at a temperature of between about 0° F. to about −10° F. The bagels are then shipped to the various facilities that prepare them to be sold.

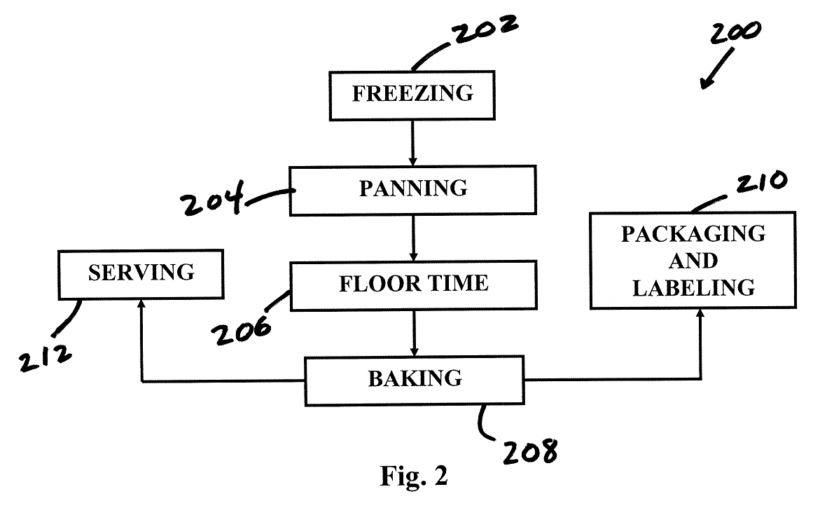

FIG. 2 shows a flow chart depicting an exemplary process for handling and preparing bagels once they have been processed according to the steps of FIG. 1. This process (shown as reference numeral 200) begins with placing the frozen bagels into a freezer (step 202). More particularly, after the bagels have been shipped and distributed by the processing facility, the bagels are typically stored until they are ready for sale. During the transportation and storage processes, the bagels are kept within freezer units, which are designed to safely maintain and preserve the ingredients of the bagels prior to consumption. In certain exemplary embodiments herein, the bagels are kept within freezer units that have an internal temperature of from about 0° F. to about −10° F.

When the bagels are ready to be sold to the end consumer, they are removed from the freezer unit and then placed onto pans lined with parchment paper, a step commonly referred to as “panning” (step 204), and prepared for baking. To facilitate this process, the temperature of the room where the panning process is performed is typically kept at ambient levels (e.g., about room temperature—i.e., from about 65° F. to about 75° F.).

After the bagels have been panned, they are typically left to sit for a specific period of time (e.g., floor time) before being placed into the oven (step 206). More particularly, conventional/traditional bagel handling procedures required that the bagels have a core temperature of approximately 55° F. before being placed into the proofer. To achieve this core temperature, the bagels typically had to endure a floor time of 90 to 240 minutes or more. Moreover, once the bagels reached this desired core temperature, they were also required to undergo a post-freezer proofing process, which would further raise their core temperature to approximately 90° F. This post-freezer proofing process typically added at least another 90 minutes to the handling process. Because of these two steps (i.e., subjecting the bagels to an extended floor time period and subjecting the bagels to a post-freezer proofing process), the distribution facilities were often forced to undergo a lengthy and time-consuming preparation process before the bagels were ready to be baked. In addition to being time-consuming, these processes also placed the bagels at risk of becoming contaminated, as well as becoming misshapen or experiencing one or more unappealing surface flaws due to unstable conditions during the waiting period. The inventors of the present invention, however, have invented a process that substantially minimizes this waiting period by creating a fully fermented freezer-to-oven bagel producing process. In other words, the amount of time the bagel is required to be left out of the freezer before being placed into the oven is very minimal relative to conventional bagel handling procedures. More particularly, after the bagels are panned (step 204), they can be placed in the oven after a floor time of only about 1 to about 20 minutes (step 206). Not only is this floor time substantially less than that of conventional bagel making processes, but the present process also does not require the bagels to be further proofed after exiting the freezer unit.

Once the floor time has expired, the bagels are then placed into the oven unit to be baked (step 208). Useful baking parameters in accordance with the present invention are typically about 400° F. to about 450° F., for about 15 minutes to about 20 minutes, more particularly about 400° F., for about 16 minutes to about 18 minutes. During the baking process, the bagels are subjected to a steaming process, which lasts typically from about 35 seconds to about 45 seconds, more particularly about 40 seconds. A delay of about 60 seconds may further be incorporated into the baking process. More particularly, the fan motor that circulates hot air into the baking chamber is dormant for about 60 seconds. Moreover, it may be useful to close the damper or vent that allows the hot air and/or steam to escape the oven during the process.

During the baking process, it is typical for the bagels to increase in size (i.e., the dimensions and volume of the bagels increase). While conventional bagel products undergo a substantial increase in size during the post-freezing and baking processes, the bagels of the current invention do not experience such a size increase, particularly as the processing steps described in FIG. 1 cause the bagel to expand to a size that is more closely representative of a typical fully baked bagel. To illustrate the difference between the size/volume increase of conventional bagels and those produced by the bagel forming process according to the present invention, Tables 2a-b and 3a-b are provided below. These tables show the dimensional and volumetric increase of sample bagels before and after being baked by a conventional baking process (Tables 2a and b) and the presently disclosed process (Tables 3a and b). As can been seen from the Tables, the dimensional and volumetric increase of the conventional bagels was 290%, while the bagels prepared by the current process had a dimensional and volumetric increase of only 177%. It is also apparent from Tables 3a and 3b that the frozen bagels produced according to the present invention have a volume greater than 50% of the volume of the bagels after being baked.

The ingredients (and their respective percentages) used in accordance with the processes shown in Tables 2 and 3 below are listed above in Table 1. The conventional process included a proof temperature of 90° F. (with 90% relative humidity), a bake temperature of 450° F. for 12 minutes, together with 15 seconds steam, and a delay for 40 seconds with the damper closed. The Freezer-to-Oven process included a 15 minute floor time, bake temperature of 400° F. for 16 minutes with 40 seconds of steam and a 60 second delay, with the damper closed.

Conventional Process

| Table 2a: Raw | | | | | | | | |
|---|---|---|---|---|---|---|---|---|
| Dimensions/Volume | | | | | Table 2b: Baked Dimensions/Volume | | | |
| Diameter | | | Volume | % of baked | Diameter | | | |
| (in)* | | Height (in) | (ml) | Volume | (in)* | | Height (in) | Volume (ml) |
| 3.3 | 3.3 | 1.2 | 125 | 33% | 4.6 | 4.3 | 1.7 | 375 |
| 3.3 | 3.2 | 1.2 | 125 | 36% | 4.6 | 4.4 | 1.6 | 350 |
| 3.4 | 3.1 | 1.2 | 125 | 33% | 4.6 | 4.5 | 1.7 | 375 |
| 3.5 | 3.3 | 1.2 | 125 | 36% | 4.7 | 4.5 | 1.7 | 350 |
| 3.4 | 3.2 | 1.1 | 125 | 36% | 4.7 | 4.4 | 1.7 | 350 |
| 3.3 | 3.2 | 1.1 | 125 | 33% | 4.6 | 4.5 | 1.7 | 375 |
| 3.3 | 3.1 | 1.2 | 125 | 33% | 4.7 | 4.4 | 1.7 | 375 |
| 3.4 | 3.3 | 1.2 | 125 | 36% | 4.7 | 4.5 | 1.7 | 350 |
| | | average | 125 | 35% | | | average | 363 |

Freezer-to-Oven Process

| Table 3a: Raw | | | | | | Table 3b: Baked | | | |
|---|---|---|---|---|---|---|---|---|---|
| Dimensions/Volume | | | | | Pre Freeze | Dimensions/Volume | | | |
| Diameter | | Height | Volume | % of baked | Temperature | Diameter | | Height | Volume |
| (in)* | | (in) | (ml) | Vol. | Ranges | (in)* | | (in) | (ml) |
| 4.5 | 4.4 | 1.2 | 225 | 53% | 0 F. temperature | 4.9 | 4.7 | 1.8 | 425 |
| 4.6 | 4.3 | 1.2 | 225 | 56% | | 4.9 | 4.7 | 1.6 | 400 |
| 4.6 | 4.5 | 1.2 | 225 | 56% | | 4.8 | 4.8 | 1.8 | 400 |
| 4.7 | 4.3 | 1.2 | 225 | 56% | −10 F. | 4.9 | 4.6 | 1.7 | 400 |
| 4.6 | 4.2 | 1.2 | 225 | 56% | Temperature | 4.7 | 4.7 | 1.8 | 400 |
| 4.6 | 4.4 | 1.2 | 225 | 56% | | 4.9 | 4.7 | 1.8 | 400 |
| | | average | 225 | 55.5% | | | | average | 404 |

Preliminary freeze Ranges used for Freezer-to-Oven Process results above.

| | | dwell time | core temp | surface temp |
|---|---|---|---|---|
| Preliminary freeze | Preliminary freeze @ | 14 min | 36 F. | 8 F. |
| Ranges: | −10 F.: | | | |
| | Preliminary freeze @ | 20 min | 40 F. | 17 F. |
| | 0 F.: | | | |

Volume increase from raw to baked:
conventional = 290%;
current process = 177%
*Note - two diameter measurements are provided for the bagels since the bagels themselves are not perfectly round. These two measurements represent the long and short sides of the bagel's diameter, respectively.

Once the bagels are fully baked, they can either be packaged and labeled for later sale (step 210) or served straight out of the oven (step 212) to a consumer.

Advantages and improvements of the processes and methods of the present invention are demonstrated in the following examples. The examples are illustrative only and are not intended to limit or preclude other embodiments of the invention.

### EXAMPLE 1

### Cinnamon Raisin Bagels

Cinnamon raisin bagels were prepared in accordance with the present invention as follows: First, a batch of bagel dough was prepared by combining the following ingredients in the amounts shown. The ingredients were placed in a horizontal mixer.

| Ingredient | Weight | U/M |
|---|---|---|
| Bulk Flour (Unbleached) | 800 | lb |
| Water | 373 | lb |
| High Fructose Corn Syrup | 60 | lb |
| Non Diastatic Malt | 8 | lb |
| Salt | 16 | lb |
| Vital Wheat Gluten | 15 | lb |
| Ground Cinnamon (KA) | 8 | lb |
| Bagel Conditioner | 16 | lb |
| Cellulose Gum | 1.6 | lb |
| Natural Flavor | 4 | lb |
| Ascorbic Acid (30 ppm Tablets) | 16 tablets | tabs |
| Compressed Yeast | 25 | lb |

Mix for 4 minutes at low speed and then for 6.5 minutes at high speed

| | | |
|---|---|---|
| Raisins | 60 | lb |
| Raisins | 25 | lb |

Mix for 1 minute at low speed and then for 1 minute at high speed

| | | |
|---|---|---|
| Carmel Color | 2.5 | lb |

Mix for 25 seconds at high speed

The batch yield was 1409.10 pounds, of which the scaled weight of the individual dough products was 4.50 ounces (i.e., 128 grams). 418 dozen units were produced from this batch.

The ingredients were blended in the mixer for approximately 11 minutes until the dough was uniformly mixed. The dough temperature after the mixing process was approximately 80° F. (+/−2° F.). Once the ingredients were mixed into the batch, the batch was then divided into individual portions or units. As mentioned above, the individual bagel units were scaled to a weight of approximately 4.50 ounces (approximately 128 grams). The bagels were then subjected to a hang-time of approximately 13.71 minutes. During the mixing process and hang time, the room conditions were kept between 70% to about 80% relative humidity and between about 65° F. to about 75° F.

The divided dough products were then formed into the shape of individual bagels by a horizontal belt forming machine having a 3.125″ sleeve, 2.0″ mandrel and 9.6 rough top 3-ply belt. The formed bagels were then removed from the belt and put in groups of 15 onto a cornmeal-coated board in a 3×5 pattern. More particularly the bagels were centered on the board in an arrangement having a 6.5″ width and a length of 5″ The boards were loaded at a rate of approximately 23.33 boards per minute (i.e., 1 board every 3.88 seconds). Once each board had been fully loaded with bagels, it was then placed on a rack. The boards were loaded into the racks at a pace of approximately 27 racks per hour.

Once the dough products were formed into shape and placed onto the corn-meal coated boards, the products were then subjected to a proofing process by being placed into a manual proof box. The proof box had a relative humidity between 80% and 100% and a temperature of 75° F. (wet and dry). The proofing process lasted between 2 and 2.5 hours.

After the bagels were removed from the proof box, they then underwent a preliminary freezing process. More particularly, the bagels were placed in a freezer having a temperature of 0° F. The bagels were left in the freezer for approximately 20 minutes, after which time their core temperature had lowered to approximately 45° F.

The bagels were then stripped from the boards and placed into a commercial spiral blast freezer for 30 minutes. The temperature of the blast freezer was set at −29° F., which caused the core temperature of the bagels to be lowered to approximately 5° F. at the time of exit from the freezer.

After the bagels were subjected to the blast freezing process, they were then scanned by a commercial metal detector, and then packaged and prepared for shipping and distribution. The shelf life of the frozen bagels was determined to be 120 days.

### EXAMPLE 2

### Onion Bagels

Onion bagels were prepared in accordance with the present invention as follows: First, a batch of bagel dough was prepared by combining the following ingredients in the amounts shown. The ingredients were placed in a horizontal mixer.

| Ingredient | Weight | U/M |
|---|---|---|
| Bulk Flour (Unbleached) | 800 | lb |
| Water | 374 | lb |
| High Fructose Corn Syrup | 60 | lb |
| Non Diastatic Malt | 8 | lb |
| Salt | 16 | lb |
| Vital Wheat Gluten | 15 | lb |
| Bagel Conditioner | 16 | lb |
| Minced Onions | 36 | lb |
| Poppy Seeds | 16 | lb |
| Natural Flavor | 4 | lb |
| Compressed Yeast | 16 | lb |

Mix for 4 minutes at low speed and then for 6 (+/−1) minutes at high speed

The batch yield was 1356.00 pounds, of which the scaled weight of the individual dough products was 4.50 ounces (i.e., 128 grams). 402 dozen units were produced from this batch.

The ingredients were blended in the mixer for approximately 11 minutes until the dough was uniformly mixed. The dough temperature after the mixing process was approximately 80° F. (+/−2° F.). Once the ingredients were mixed into the batch, the batch was then divided into individual portions or units. As mentioned above, the individual bagel units were scaled to a weight of approximately 4.50 ounces (approximately 128 grams). The bagels were then subjected to a hang-time of approximately 13.71 minutes. During the mixing process and hang time, the room conditions were kept between 70% to about 80% relative humidity and between about 65° F. to about 75° F.

The divided dough products were then formed into the shape of individual bagels by a horizontal belt forming machine having a 3.125″ sleeve, 2.0″ mandrel and 9.6 rough top 3-ply belt. The formed bagels were then removed from the belt and put in groups of 15 onto a cornmeal-coated board in a 3×5 pattern. More particularly the bagels were centered on the board in an arrangement having a 6.5″ width and a length of 5″. The boards were loaded at a rate of approximately 23.33 boards per minute (i.e., 1 board every 3.88 seconds). Once each board had been fully loaded with bagels, it was then placed on a rack. The boards were loaded into the racks at a pace of approximately 27 racks per hour.

Once the dough products were formed into shape and placed onto the corn-meal coated boards, the products were then subjected to a proofing process by being placed into a manual proof box. The proof box had a relative humidity between 80% and 100% and a temperature of 75° F. (wet and dry). The proofing process lasted between 2 and 2.5 hours.

After the bagels were removed from the proof box, they then underwent a preliminary freezing process. More particularly, the bagels were placed in a freezer having a temperature of 0° F. The bagels were left in the freezer for approximately 20 minutes, after which time their core temperature had lowered to approximately 45° F.

The bagels were then stripped from the boards and placed into a commercial spiral blast freezer for 30 minutes. The temperature of the blast freezer was set at −29° F., which caused the core temperature of the bagels to be lowered to approximately 5° F. at the time of exit from the freezer.

After the bagels were subjected to the blast freezing process, they were then scanned by a commercial metal detector, and then packaged and prepared for shipping and distribution. The shelf life of the frozen bagels was determined to be 120 days.

### EXAMPLE 3

### Plain Bagels

Plain bagels were prepared in accordance with the present invention as follows: First, a batch of bagel dough was prepared by combining the following ingredients in the amounts shown. The ingredients were placed in a horizontal mixer.

| Ingredient | Weight | U/M |
|---|---|---|
| Bulk Flour (Unbleached) | 800 | lb |
| Water | 340 | lb |
| High Fructose Corn Syrup | 80 | lb |
| Non Diastatic Malt | 8 | lb |
| Salt | 16 | lb |
| L-Cystine (40 ppm tablets) | 6 tablets | tabs |
| Vital Wheat Gluten | 8 | lb |
| Bagel Conditioner | 16 | lb |
| Natural Flavor | 4 | lb |
| Compressed Yeast | 16 | lb |

Mix for 4 minutes at low speed and then for 5 (+/−1) minutes at high speed

The batch yield was 1288.00 pounds, of which the scaled weight of the individual dough products was 4.50 ounces (i.e., 128 grams). 382 dozen units were produced from this batch.

The ingredients were blended in the mixer for approximately 11 minutes until the dough was uniformly mixed. The dough temperature after the mixing process was approximately 80° F. (+/−2° F.). Once the ingredients were mixed into the batch, the batch was then divided into individual portions or units. As mentioned above, the individual bagel units were scaled to a weight of approximately 4.50 ounces (approximately 128 grams). The bagels were then subjected to a hang-time of approximately 13.71 minutes. During the mixing process and hang time, the room conditions were kept between 70% to about 80% relative humidity and between about 65° F. to about 75° F.

The divided dough products were then formed into the shape of individual bagels by a horizontal belt forming machine having a 3.125″ sleeve, 2.0″ mandrel and 9.6 rough top 3-ply belt. The formed bagels were then removed from the belt and put in groups of 15 onto a cornmeal-coated board in a 3×5 pattern. More particularly the bagels were centered on the board in an arrangement having a 6.5″ width and a length of 5″. The boards were loaded at a rate of approximately 23.33 boards per minute (i.e., 1 board every 3.88 seconds). Once each board had been fully loaded with bagels, it was then placed on a rack. The boards were loaded into the racks at a pace of approximately 27 racks per hour.

Once the dough products were formed into shape and placed onto the corn-meal coated boards, the products were then subjected to a proofing process by being placed into a manual proof box. The proof box had a relative humidity between 80% and 100% and a temperature of 75° F. (wet and dry). The proofing process lasted between 2 and 2.5 hours.

After the bagels were removed from the proof box, they then underwent a preliminary freezing process. More particularly, the bagels were placed in a freezer having a temperature of 0° F. The bagels were left in the freezer for approximately 20 minutes, after which time their core temperature had lowered to approximately 45° F.

The bagels were then stripped from the boards and placed into a spiral blast freezer for 30 minutes. The temperature of the blast freezer was set at −29° F., which caused the core temperature of the bagels to be lowered to approximately 5° F. at the time of exit from the freezer.

After the bagels were subjected to the blast freezing process, they were then scanned by a commercial metal detector, and then packaged and prepared for shipping and distribution. The shelf life of the frozen bagels was determined to be 120 days.

### EXAMPLE 4

### Wheat Bagels

Wheat bagels were prepared in accordance with the present invention as follows: First, a batch of bagel dough was prepared by combining the following ingredients in the amounts shown. The ingredients were placed in a horizontal mixer.

| Ingredient | Weight | U/M |
|---|---|---|
| Bulk Flour (Unbleached) | 500 | lb |
| Whole Wheat Flour | 300 | lb |
| Water | 369 | lb |
| Light Amber Liquid Honey | 96 | lb |
| Non Diastatic Malt | 8 | lb |
| Salt | 16 | lb |
| Vital Wheat Gluten | 16 | lb |
| Bagel Conditioner | 16 | lb |
| Natural Flavor | 4 | lb |
| Compressed Yeast | 24 | lb |

Mix for 4 minutes at low speed and then for 7 (+/−1) minutes at high speed

The batch yield was 1349.00 pounds, of which the scaled weight of the individual dough products was 4.50 ounces (i.e., 128 grams). 400 dozen units were produced from this batch.

The ingredients were blended in the mixer for approximately 11 minutes until the dough was uniformly mixed. The dough temperature after the mixing process was approximately 80° F. (+/−2° F.). Once the ingredients were mixed into the batch, the batch was then divided into individual portions or units. As mentioned above, the individual bagel units were scaled to a weight of approximately 4.50 ounces (approximately 128 grams). The bagels were then subjected to a hang-time of approximately 13.71 minutes. During the mixing process and hang time, the room conditions were kept between 70% to about 80% relative humidity and between about 65° F. to about 75° F.

The divided dough products were then formed into the shape of individual bagels by a horizontal belt forming machine having a 3.125″ sleeve, 2.0″ mandrel and 9.6 rough top 3-ply belt. The formed bagels were then removed from the belt and put in groups of 15 onto a cornmeal-coated board in a 3×5 pattern. More particularly the bagels were centered on the board in an arrangement having a 6.5″ width and a length of 5″. The boards were loaded at a rate of approximately 23.33 boards per minute (i.e., 1 board every 3.88 seconds). Once each board had been fully loaded with bagels, it was then placed on a rack. The boards were loaded into the racks at a pace of approximately 27 racks per hour.

Once the dough products were formed into shape and placed onto the corn-meal coated boards, the products were then subjected to a proofing process by being placed into a manual proof box. The proof box had a relative humidity between 80% and 100% and a temperature of 75° F. (wet and dry). The proofing process lasted between 2 and 2.5 hours.

After the bagels were removed from the proof box, they then underwent a preliminary freezing process. More particularly, the bagels were placed in a freezer having a temperature of 0° F. The bagels were left in the freezer for approximately 20 minutes, after which time their core temperature had lowered to approximately 45° F.

The bagels were then stripped from the boards and placed into a commercial spiral blast freezer for 30 minutes. The temperature of the blast freezer was set at −29° F., which caused the core temperature of the bagels to be lowered to approximately 5° F. at the time of exit from the freezer.

After the bagels were subjected to the blast freezing process, they were then scanned by a commercial metal detector, and then packaged and prepared for shipping and distribution. The shelf life of the frozen bagels was determined to be 120 days.

### EXAMPLE 5

### Plain Bagels

Plain bagels were prepared in accordance with the present invention as follows: First, a batch of bagel dough was prepared by combining ingredients in the amounts shown. The ingredients were placed in a horizontal mixer.

| Ingredient | Weight | U/M |
|---|---|---|
| Bulk Flour (Unbleached) | 500 | lb |
| Water | 245 | lb |
| High Fructose Corn Syrup | 50 | lb |
| Non Diastatic Malt | 5 | lb |
| Salt | 10 | lb |
| Vital Wheat Gluten | 10 | lb |
| Bagel Conditioner | 10 | lb |
| Natural Flavor | 2.5 | lb |
| Compressed Yeast | 10 | lb |

Mix for 4 minutes at low speed and then for 5 (+/−1) minutes at high speed

The batch yield was 843 pounds, of which the scaled weight of the individual dough products was 4.50 ounces (i.e., 128 grams). 250 dozen units were produced from this batch.

The ingredients were blended in the mixer for approximately 11 minutes until the dough was uniformly mixed. The dough temperature after the mixing process was approximately 72° F. (+/−2° F.). Once the ingredients were mixed into the batch, the batch was then divided into individual portions or units. As mentioned above, the individual bagel units were scaled to a weight of approximately 4.50 ounces (approximately 128 grams). The bagels were then subjected to a hang-time of approximately 13.71 minutes. During the mixing process and hang time, the room conditions were kept between 70% to about 80% relative humidity and between about 65° F. to about 75° F.

The divided dough products were then formed into the shape of individual bagels by a horizontal belt forming machine having a 3.125″ sleeve, 2.0″ mandrel and 9.6 rough top 3-ply belt. The formed bagels were then removed from the belt and put in groups of 15 onto a cornmeal-coated board in a 3×5 pattern. More particularly the bagels were centered on the board in an arrangement having a 6.5″ width and a length of 5″. The boards were loaded at a rate of approximately 23.33 boards per minute (i.e., 1 board every 3.88 seconds). Once each board had been fully loaded with bagels, it was then placed on a rack. The boards were loaded into the racks at a pace of approximately 27 racks per hour.

Once the dough products were formed into shape and placed onto the corn-meal coated boards, the products were then subjected to a proofing process by being placed into a manual proof box. The proof box had a relative humidity around 80% and a temperature of 68° F. dry and 66° F. wet. The proofing process lasted between 3.75 and 4.0 hours.

After the bagels were removed from the proof box, they then underwent a preliminary freezing process. More particularly, the bagels were placed in a freezer having a temperature of 0° F. The bagels were left in the freezer for approximately 20 minutes, after which time their core temperature had lowered to approximately 45° F.

The bagels were then stripped from the boards and placed into a commercial spiral blast freezer for 30 minutes. The temperature of the blast freezer was set at −29° F., which caused the core temperature of the bagels to be lowered to approximately 5° F. at the time of exit from the freezer.

After the bagels were subjected to the blast freezing process, they were then scanned by a commercial metal detector, and then packaged and prepared for shipping and distribution. The shelf life of the frozen bagels was determined to be 9 months.

### EXAMPLE 6

### Plain Bagels

Plain bagels were prepared in accordance with the present invention as follows: First, a batch of bagel dough was prepared by combining the following ingredients in the amounts shown. The ingredients were placed in a horizontal mixer.

| Ingredient | Weight | U/M |
|---|---|---|
| Bulk Flour (Unbleached) | 800 | lb |
| Water | 340 | lb |
| High Fructose Corn Syrup | 80 | lb |
| Non Diastatic Malt | 8 | lb |
| Salt | 16 | lb |
| L-Cystine (40 ppm tablets) | 6 tablets | tabs |
| Vital Wheat Gluten | 8 | lb |
| Bagel Conditioner | 16 | lb |
| Natural Flavor | 4 | lb |
| Compressed Yeast | 16 | lb |

Mix for 4 minutes at low speed and then for 5 (+/−1) minutes at high speed

The batch yield was 1288.00 pounds, of which the scaled weight of the individual dough products was 4.50 ounces (i.e., 128 grams). 382 dozen units were produced from this batch.

The ingredients were blended in the mixer for approximately 11 minutes until the dough was uniformly mixed. The dough temperature after the mixing process was approximately 80° F. (+/−2° F.). Once the ingredients were mixed into the batch, the batch was then divided into individual portions or units. As mentioned above, the individual bagel units were scaled to a weight of approximately 4.50 ounces (approximately 128 grams). The bagels were then subjected to a hang-time of approximately 13.71 minutes. During the mixing process and hang time, the room conditions were kept between 70% to about 80% relative humidity and between about 65° F. to about 75° F.

The divided dough products were then formed into the shape of individual bagels by a horizontal belt forming machine having a 3.125″ sleeve, 2.0″ mandrel and 9.6 rough top 3-ply belt. The formed bagels were then removed from the belt and put in groups of 15 onto a cornmeal-coated board in a 3×5 pattern. More particularly the bagels were centered on the board in an arrangement having a 6.5″ width and a length of 5″. The boards were loaded at a rate of approximately 23.33 boards per minute (i.e., 1 board every 3.88 seconds). Once each board had been fully loaded with bagels, it was then placed on a rack. The boards were loaded into the racks at a pace of approximately 27 racks per hour.

Once the dough products were formed into shape and placed onto the corn-meal coated boards, the products were then subjected to a proofing process by being placed into a manual proof box. The proof box had a relative humidity of 100% and a temperature of 75° F. (wet and dry). The proofing process lasted between 2 and 2.5 hours.

After the bagels were removed from the proof box, they then underwent a preliminary freezing process. More particularly, the bagels were placed in a freezer having a temperature of 0° F. The bagels were left in the freezer for approximately 20 minutes, after which time their core temperature had lowered to approximately 45° F.

The bagels were then stripped from the boards and placed into a commercial spiral blast freezer for 30 minutes. The temperature of the blast freezer was set at −29° F., which caused the core temperature of the bagels to be lowered to approximately 5° F. at the time of exit from the freezer.

After the bagels were subjected to the blast freezing process, they were then scanned by a commercial metal detector, and then packaged and prepared for shipping and distribution. The shelf life of the frozen bagels was determined to be 120 days.

While exemplary embodiments incorporating the principles of the present teachings have been disclosed hereinabove, the present teachings are not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A process for making a freezer-to-oven bagel product, comprising:
mixing ingredients to form a bagel dough, the ingredients including at least yeast;
dividing the bagel dough to form individual bagel units;
proofing the bagel units to cause the bagel dough to rise;
preliminarily freezing the bagel units; and
blast freezing the bagel units to produce frozen bagel units, each having a volume greater than 50% of a volume of the bagel unit after it is baked.

2. The process of claim 1, wherein the preliminary freezing step is performed in a freezer having an internal temperature of from about 0° F. to about −10° F.

3. The process of claim 2, wherein the preliminary freezing step is performed for a time of about 10 to about 30 minutes.

4. The process of claim 1, wherein the proofing step is performed at a temperature of about 68° F. to 75° F.

5. The process of claim 4, wherein the proofing step is performed at a relative humidity of from about 80% to about 100%.

6. The process of claim 5, wherein the preliminary freezing step is performed for a time of about 2 to about 4 hours.

7. A process for making a freezer-to-oven bagel product, comprising:
mixing ingredients to form a bagel dough, the ingredients including at least flour, liquid, and yeast;
dividing the bagel dough to form individual bagel units;
proofing the bagel units for about 2 to about 4 hours in a proof box, the proof box having an internal temperature of from about 68° F. to about 75° F. and a relative humidity of from about 80% to about 100%;
preliminarily freezing the bagel units for about 10 to about 30 minutes in a freezer, the freezer having an internal temperature of from about 0° F. to about −10° F.; and
blast freezing the bagel units to produce frozen bagel units.

8. The process of claim 7, wherein the blast freezing step is performed at a temperature of about −20° F. to about −30° F.

9. The process of claim 7, further comprising placing the individual bagel units onto boards coated in cornmeal before subjecting the units to the proofing step.

10. The process of claim 9, further comprising stripping the individual bagel units from the boards before subjecting the units to the blast freezing step.

11. The process of claim 7, wherein the individual bagel units have a core temperature of from about 35° F. to about 55° F. after the preliminary freezing step.

12. The process of claim 7, wherein the frozen bagel units have a core temperature of about 0° F. to about 10° F. after blast freezing.

13. The process of claim 7, wherein the frozen bagel units each have a volume which is greater than 50% of the volume of the bagel units after it is baked.

14. The process of claim 12, wherein the frozen bagel units have a floor time at an ambient temperature of from about 15 minutes to about 20 minutes before being baked in the oven.

15. A process for making a freezer-to-oven bagel product, comprising:
preparing bagel dough from a mixture containing at least flour, liquid, and yeast;
forming the bagel dough into individual bagel units;
proofing the bagel units for about 2 to about 4 hours in a proof box, the proof box having an internal temperature of from about 68° F. to about 75° F. and a relative humidity of from about 80% to about 100%;
preliminarily freezing the bagel units for about 10 to about 30 minutes in a freezer, the freezer having an internal temperature of from about 0° F. to about −10° F.;
blast freezing the bagel units for about 20 to about 30 minutes in a blast freezer, the blast freezer having an internal temperature of from about −20° F. to about −30° F. to produce frozen bagel units each having a volume greater than 50% of a volume of the bagel unit after it is baked.

16. The process of claim 15, further comprising placing the individual bagel units onto boards coated in cornmeal before subjecting the units to the proofing step.

17. The process of claim 16, further comprising stripping the individual bagel units from the boards before subjecting the units to the blast freezing step.

18. The process of claim 15, wherein the individual bagel units have a core temperature of from about 40° F. to about 50° F. after the preliminary freezing step.

19. The process of claim 15, wherein the frozen bagel units have a core temperature of about 0° F. to about 10° F. after blast freezing.

20. The process of claim 15, wherein the frozen bagel units have a floor time at an ambient temperature of from about 15 minutes to about 20 minutes before being baked in the oven.
